(19) United States
(12) Patent Application Publication
(10) Pub. No.: US 2005/0136158 A1
(43) Pub. Date: Jun. 23, 2005

(54) Binding a previously prepared grain-based product to a support member

(76) Inventor: Michael Paparo, Ft. Lauderdale, FL (US)

Correspondence Address: AKERMAN SENTERFITT, P.O. BOX 3188, WEST PALM BEACH, FL, 33402-3188, US

(21) Appl. No.: 10/746,578

(22) Filed: Dec. 23, 2003

(51) Int. Cl. A23G 1/00

(52) U.S. Cl. 426/134

(57) ABSTRACT

A method for affixing a support member to a grain-based edible can include the step of directly coupling an extruded support member to the grain-based edible. The grain-based edible coupled to the support member can be soaked in an edible mixture after the grain-based edible has been baked. The grain-based edible coupled to the support member can be heated until the mixture absorbed within the grain-based edible is approximately solidified. The heating can enhance the adhesive characteristics between the grain-based edible and the support member such that the adhesive characteristics are sufficient to permit the grain-based edible to be held by the extruded portion of the support member during ingestion of the grain-based edible without the un-ingested portion of the grain-based edible decoupling from the support member.

### BACKGROUND

1. Field of the Invention

The present invention relates to the field of convenience foods and, more particularly, to mounting a grain-based edible food, such as French toast, to a support member.

2. Description of the Related Art

We live in a fast-paced society where food is often quickly grabbed and ingested by hurried consumers as they rush to work, school, or elsewhere. As a result, many traditionally consumed food items, which consumers cannot devour on the run, are seldom eaten. Instead, less healthy, highly processed foods like donuts, pastries, cookies, bagels, and muffins have capitalized the breakfast niche.

One method of increasing the portability and convenience of a food product involves coupling the food product to a sanitary support member, such as a stick, so that a consumer can hold the support member when ingesting the food product. Prior art includes mounted food products such as popsicles, lollipops, and cotton candy, each of which utilizes significantly different coupling methodologies and involves structurally different adhesive characteristics from a supported grain-based edible.

A few traditional grain-based edible products have been affixed to a support member for consumption. One conventional category of grain-based supported edibles includes a meat product encased within a batter, where a support member is affixed to the encased meat. One such product includes a corn dog, which is a frankfurter that is encased in corn bread batter before the batter is baked or fried. Corndogs often include a centrally mounted support stick affixed to the encased frankfurter. A derivative of the corn dog, sometimes called a pancake on a stick, encases a sausage within a batter that is baked or fried. In both instances, the supporting stick is coupled to the encased meat product as opposed to being directly coupled to the grain-based product.

Another edible meat product with a supporting stick can include a shish kabob. A shish kabob, which often includes only cooked pieces of meat, can be topped with a piece of bread. Like the corn dog, the stick member is primarily affixed to the meat product, as the coupling between the stick and the piece of bread is a relatively weak coupling compared to that between the more solid meat product and the stick. The tip of a shish kabob can be quite sharp (in order to pierce the meat) and the bread topping is often placed upon the shish kabob as a protective measure to prevent a wielder of the shish kabob from inadvertently piercing bystanders. It can be unwise for a consumer to ingest the bread topping directly from the stick, as this can result in the interior of the mouth being poked with the sharp stick resulting in damage to the mouth.

Additionally, a variety of different grain-based edible food products have been coupled to supporting stick members in the past. Each of these conventional food products, however, requires that the support member be inserted into uncooked tacky dough in order to achieve the degree of adhesion necessary to support the grain-based edible. Often a mold is used to position the support member during the cooking process. The dough is then cooked by baking or frying, resulting in a relatively strong bond between the support member and the grain-based product.

Presently, grain-based edibles cannot be adequately affixed to a support member after the grain-based edible has been baked. Further, the soaking of a supported grain-based edible in a liquid or semi-liquid mixture results in the grain-based edible becoming less rigid, resulting in a decoupling of the grain-based edible and the support member. Accordingly, numerous conventional grain-based food products, such as French toast, cannot be prepared so that the grain-based edible is coupled to a support member using conventional techniques.

### SUMMARY OF THE INVENTION

The present invention provides a method, a system, and an apparatus relating to a supported grain-based edible. More specifically, the instant invention couples a baked grain-based edible, such as French toast, to a support member, such as a pop stick or tongue depressor. Accordingly, a consumer can hold the support member when eating the breakfast pop so that the grain-based edible can be rapidly eaten in a sanitary fashion without leaving food residue on the consumer's hands. Because of the support member, a consumer need not use silverware to hygienically ingest the food product, even though the grain-based edible can be coated with sugar, cinnamon, sprinkles, chocolate, syrup, and the like. Consequently, the present invention provides a means for allowing grain-based edibles, even coated ones, to be eaten with the same level of convenience as that associated with traditional convenience foods, such as donuts, bagels, croissants, muffins, toaster pastries, and the like.

One particularly important aspect of the present invention relates the enhanced adhesive qualities achieved by soaking a previously prepared (baked) grain-based edible in a mixture, such as a mixture of milk and egg. The absorbed edible mixture can be solidified by frying the grain-based edible in a fat or oil, while the grain-based edible is coupled to the support member. The solidifying of the mixture results in a strong coupling between the support member and the grain-based edible; the coupling is strong enough for the grain-based edible to be ingested while a consumer holds an extruded segment of the support member without the grain-based edible decoupling from the support member.

One aspect of the present invention can include a method for affixing a support member to a grain-based edible. The method can include the step of directly coupling an extruded support member to the grain-based edible. In one embodiment, the support member can be coated with an edible bonding agent before being coupled to the grain-based edible. The edible bonding agent can enhance the coupling between the grain-based edible and the support member. Additionally, the grain-based edible coupled to the support member can be soaked in an edible mixture after the grain-based edible has been baked, where the edible mixture can include milk, a milk substitute, an egg, and/or an egg substitute. The grain-based edible coupled to the support member can be heated until the mixture absorbed within the grain-based edible is approximately solidified. For example, the heating can include frying the grain-based edible within a fat or oil. The heating can enhance the adhesive characteristics between the grain-based edible and the support member such that the adhesive characteristics are sufficient to permit the grain-based edible to be held by the extruded portion of the support member during ingestion of the grain-based edible without the un-ingested portion of the grain-based edible decoupling from the support member.

In one embodiment, the coupling between the support member and the grain-based edible can occur before the grain-based edible is baked. In such an embodiment, the support member can be coupled to tacky dough, which forms the grain based edible. This dough can then be baked with the support member attached. In another embodiment, the coupling between the support member and the grain-based edible can occur after the grain based edible is baked. For example, the baked grain-based edible can be perforated with a sharp object to form a cavity within the grain-based edible. The support member can be inserted in the cavity. Pre-perforating the grain-based member before inserting the support member, as opposed to directly inserting the support member into the grain-based edible, can result in a stronger coupling than otherwise achievable.

In a particular embodiment, the grain-based edible can have an approximately rectangular shape, such as the shape of bread sliced from a loaf baked in a rectangular mold. The shape of the grain-based edible can consist of a height that is approximately equal to a length. For example, the height of the grain-based edible can be within one third of the length of the grain-based edible. Further, the width of the grain-based edible can be significantly less than the height of the grain-based edible. For example, the width can be less than one forth of the height. In the embodiment, the coupling step can further include the step of centrally positioning the support member within the grain-based edible. For example, the support member can be positioned in approximately the center of the width and in approximately the center of the length. Further, the support member can be inserted so that the inserted length of the support member is at least half of the height of the grain-based edible.

Another aspect of the present invention can include a grain-based food product that includes a grain-based edible, a support member, and an edible mixture. The grain-based edible can include baked dough formed from flour and leavening agent. In one embodiment, the grain-based edible can include embedded pieces of a non-grain-based edible, such as pieces of fruit, nuts, and/or candy. In another embodiment, the food product can also include an edible outer coating, which can include, but is not limited to, powdered sugar, candy sprinkles, cinnamon, syrup, a honey, a butter, a jam, a chocolate, and/or fruit slices. In still another embodiment, the grain-based edible can be a type of French toast.

The support member can be coupled to the grain-based edible so that one segment of the support member is centrally enclosed within the grain-based edible and another segment of the support member extrudes from the grain-based edible. In one embodiment, the extrusion can extend at least one inch beyond the grain-based edible so that the food product can be held by the extrusion.

In a particular embodiment, the support member can include a non-edible substance, such as wood and/or plastic. In another embodiment, the support member can be entirely formed form edible substances, which can include, but are not limited to, a pretzel, a sugar stick, a rock candy, a fruit bar, a chocolate bar, a toasted bread, a cracker, and the like. In still another embodiment, at least a portion of the enclosed segment of the support member can be coated with an edible coating, such as a chocolate, a candy, a sugar, a syrup, a butter, a jam, a jelly, and/or a honey.

The edible mixture can be a batter that includes milk, a milk substitute, an egg, an egg substitute, and the like. The edible mixture can be applied to the grain-based edible after the grain-based edible has been baked so that the grain-based edible absorbs the edible mixture. The coupling of the support member to the grain-based food product can be based at least in part upon a solidification of the absorbed edible mixture through heating. For example, the grain-based edible coupled to the support member can be fried after the edible mixture has been absorbed, thereby affixing the support member within the grain-based edible.

Still another aspect of the present invention can include a food product that includes a piece of French toast and a support member. One segment of the support member can be embedded within the French toast. Another segment of the support member can be extruded from the French toast. The food product can include a means for coupling the French toast to the support member. The coupling means can permit the French toast to be held by the extruded portion of the support member during ingestion without the un-ingested portion of the French toast decoupling from the support member. Further, strength of coupling means can be enhanced through heating the French toast after the French toast is coupled to the support member, where the heating of can solidify a mixture absorbed within the French toast.

### BRIEF DESCRIPTION OF THE DRAWINGS

There are shown in the drawings, embodiments that are presently preferred, it being understood, however, that the invention is not limited to the precise arrangements and instrumentalities shown.

FIG. 1 is a schematic diagram illustrating a system that includes a manner of providing a grain-based edible as a convenience food using a support member in accordance with the inventive arrangements disclosed herein.

FIG. 2A illustrates an exemplary support member having rounded ends and a relatively symmetrical shape in accordance with the inventive arrangements disclosed herein.

FIG. 2B illustrates an exemplary support member with flanged ends in accordance with the inventive arrangements disclosed herein.

FIG. 2C illustrates an exemplary support member with a guard in accordance with the inventive arrangements disclosed herein.

FIG. 2D illustrates an exemplary support member having one or more holes in accordance with the inventive arrangements disclosed herein.

FIG. 2E illustrates an exemplary arrow shaped support member in accordance with the inventive arrangements disclosed herein.

FIG. 2F illustrates an exemplary support member having a hook in accordance with the inventive arrangements disclosed herein.

FIG. 2G illustrates an exemplary support member having screw-able ridges in accordance with the inventive arrangements disclosed herein.

FIG. 2H illustrates an exemplary support member having extended teeth in accordance with the inventive arrangements disclosed herein.

FIG. 2I illustrates an exemplary support member having inverted teeth in accordance with the inventive arrangements disclosed herein.

FIG. 3 is a flow chart illustrating a method for affixing a support member to a grain-based edible in accordance with the inventive arrangements disclosed herein.

FIG. 4 is a flow chart illustrating a method for distributing a supported grain-based edible in accordance with the inventive arrangements disclosed herein.

### DETAILED DESCRIPTION OF THE INVENTION

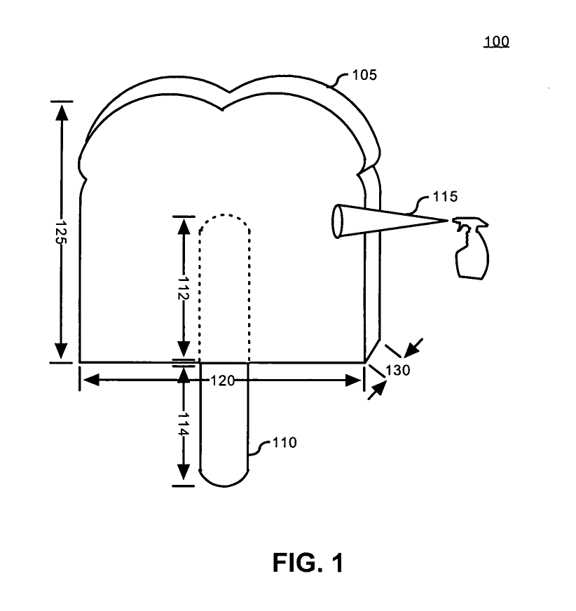

FIG. 1 is a schematic diagram illustrating a system 100 that includes a manner of providing a grain-based edible as a convenience food using a support member in accordance with the inventive arrangements disclosed herein. The system 100 can include a grain-based edible 105, a support member 110, and an edible mixture 115.

The grain-based edible 105 can be a baked edible formed from any of a variety of grains including, but not limited to, wheat, corn, rice, oats, barley, and the like. The grain can be ground and combined with a variety of substances to form a grain-based dough. The dough can include, for example, leavening agent, sugar, egg, flour, meal, and the like. The dough can also include such flavor enhancing substances as fruit, candy, chocolate chips, and the like. The dough can be baked within a variety of molds to form loaves and/or cakes of prepared bread having the shape of the molds. The loaves can then be sliced into convenient segments.

The grain-based edible 105 can comprise numerous different prepared grain-based products such as a waffle, a toast, a pancake, a pastry, a donut, and the like. Further, any of a variety of breads formed from a baked batter can be used to form the grain-based edible 105 and the invention is not limited in this regard. For example, the bread and/or meal that forms the grain-based edible 105 can include a wheat bread, a white bread, a rye bread, a pumpernickel bread, a fruit bread, a raison bread, a zucchini bread, a strawberry bread, and the like.

In one embodiment, the grain-based edible 105 can include an edible outer coating. The outer coating can include, but is not limited to, powered sugar, candy sprinkles, cinnamon, syrup, honey, a butter, a jam, a chocolate, fruit slices, coconut shavings, and the like. It should be appreciated that because the grain-based edible 105 can be grasped by the support member 110 during ingestion, the outer coating of the grain-based edible 105 will generally not be in direct contact with the hands of a consumer, thereby resulting in sanitary ingestion of the grain-based edible without utensil usage.

The support member 110 can include a segment 112 extended within the grain-based edible 105 and a segment 114 extruding from the grain-based edible 105. The extended segment 112 can be centrally positioned within the grain-based edible 105 and can be affixed to the grain-based edible through direct contact with the grain-based edible 105. The extended segment 112 can extend a distance outside the grain-based edible 110, such as one inch or more, so that a consumer can hold the extended segment 112 when ingesting the grain-based edible 105.

The support member 110 can be designed to prevent cuts and abrasions to the consumer's hands and mouth. For example, the exposed surfaces of the support member 110 can be rounded and smooth. Additionally, the support member 110 can be formed from non-edible substances as well as edible substances. Non-edible substances can include, for example, wood and plastic. Hence, in one embodiment, the support member 110 can be a pop-stick and/or a tongue depressor. Edible substances can include, but are not limited to, a pretzel, a sugar stick, a rock candy, a fruit bar, a toasted bread, a cracker, and the like.

Further, at least a portion of the support member 110, especially the extended segment 112, can be coated with a different edible substance. For example, the edible coating can include a chocolate, a candy, a sugar, a butter, a jam, a jelly, a honey, and the like. In a further arrangement, the coating of the support member 110 can function as a binding agent that enhances the adhesion between the grain-based edible 105 and the support member 110.

The positioning and shape of the support member 110 can be selected to optimize the coupling strength between the support member 110 and the grain-based edible 105. The required coupling characteristics between the support member 110 and the grain-based edible 105 can vary in accordance with the shape and composition of the grain-based edible 105. Regardless of the exact arrangement selected in particular embodiments, the adhesive characteristics between the grain-based edible 105 and the support member 110 should be such that the grain-based edible 105 can be held by the extruded segment 114 during ingestion without the un-ingested portion of the grain-based edible 105 decoupling from the support member 110.

In one embodiment, the grain-based edible 105 can be shaped in an approximately rectangular fashion, like a typical piece of bread. In such an embodiment, the enclosed segment 112 of the support member 110 can be coaxially positioned along the length 120 and the width 130 of the grain-based edible 105. That is, the segment 112 can be positioned in an approximately centralized fashion in regards to the width 130 and length 120 of the grain-based edible 105. Further, the segment 112 can extend within the grain-based member to at least half of the height 125 of the grain-based member. Such a positioning can provide sufficient support to permit the grain-based member 105 to remain coupled to the support member 110 during the ingestion process.

It should be noted that the shape of the grain-based edible 105 is not limited to an approximately rectangular shape and any of a variety of shapes can be utilized. For example, the grain-based edible 105 can be spherical, hexagonal, square, oval, cylindrical, polyhedral, and the like. The grain-based edible 105 can also be designed into pictorial shapes. For example, the grain-based edible can be shaped to resemble a pumpkin for Halloween, a tree for Christmas, a rabbit for Easter, and the like. Any shape can be selected so long as a suitable fricative surface is established between the grain-based edible 105 and the support member 110 to enable a suitable coupling between surfaces.

The edible mixture 115 can be applied to the grain-based edible 105 after the grain-based edible has been baked and after the support member 110 has been initially coupled to grain-based edible 105. The edible mixture 115 can include milk, a milk substitute, an egg, an egg substitute, and/or other batter creating substances. For example, the edible mixture 115 can be a batter in which bread is dipped in order to make French toast.

Any manner of applying the edible mixture 115 to the mixture-absorbing grain-based edible 105 can be utilized herein. For example, in one embodiment, the edible mixture 115 can be poured and/or sprayed onto the grain-based edible 105. In another embodiment, the grain-based edible 105 can be immersed into a container including the edible mixture 115, thereby permitting the grain-based edible 105 to absorb the edible mixture 115. In yet another embodiment, a hollow support member 110 can be inserted into the grain-based member 105 and the edible mixture 115 can be injected into the grain-based mixture through the hollow support member 110.

Once the edible mixture 115 has been applied to the grain-based edible 105, the grain-based edible 105 with the attached support member 110 can be heated. The heating process can solidify the edible mixture 115 resulting in the grain-based edible 105 becoming more rigid. The solidification of the edible mixture 115 can enhance the adhesive characteristics between the grain-based edible 105 and the support member 110. In one embodiment, the heating process can involve frying the grain-based edible 105 over a direct heat in oil or fat.

In a preferred embodiment of system 100, the grain-based edible 105 can be French toast and the support member 110 can be a pop stick. In such an embodiment, a piece of bread from which the French toast can be made can be identified. A knife or other sharp object can be used to perforate a cavity within the bread. The pop stick can be inserted into this cavity. Perforating the cavity before inserting the pop stick permits a tighter seal between the pop stick and the bread than would be otherwise achieved by directly thrusting the pop stick into the bread. The edible mixture 115, which can be an egg-based batter, can be poured into a bowl. The bread with the attached pop stick can be carefully immersed into the bowl, so that the bread is saturated with the egg-based batter. After being soaked, the bread and attached pop stick can be fried in oil over an open flame. After frying, a coating, such as powdered sugar, can be added to the French bread.

The frying of the bread in the above step can result in the stiffing of the bread about the pop stick. Further, the egg-batter can be partially absorbed by the pop stick when the bread was soaked, thereby resulting in a tight coupling between the pop stick and the bread once the bread has been fried. Accordingly, after the bread is fried with the pop stick attached, the pop stick can be firmly adhered to the bread so that the French toast can be ingested by holding the pop-stick.

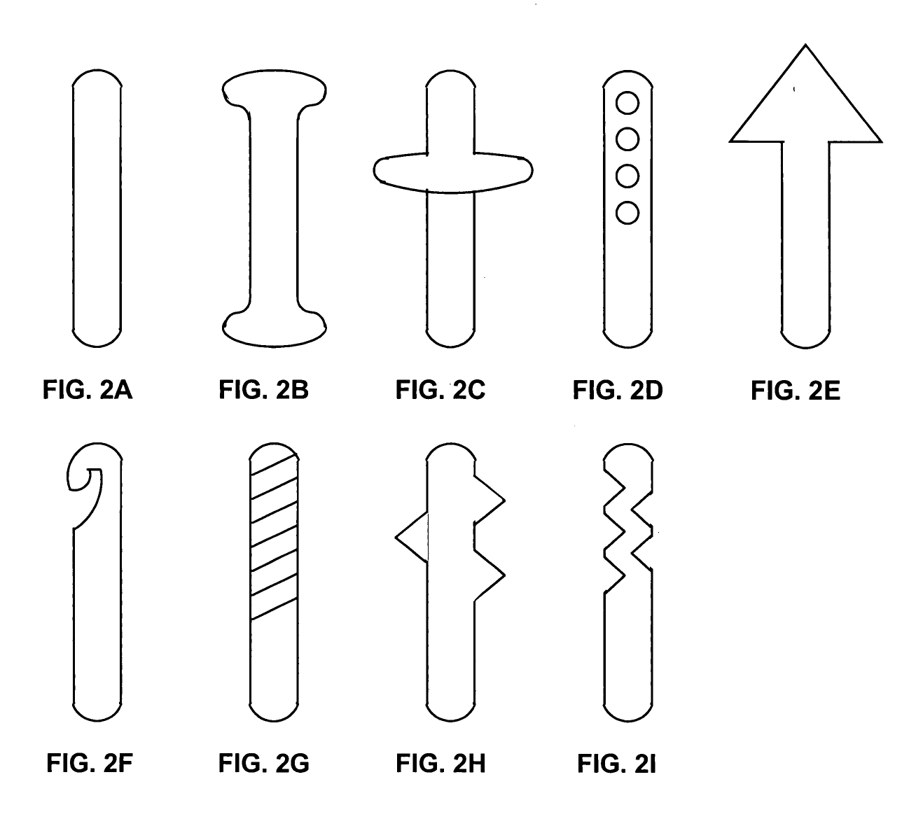

FIGS. 2A to 2I are schematic diagrams illustrating exemplary support members in accordance with the inventive arrangements disclosed herein. The support members within the FIGS. 2A to 2I can be constructed from any of a variety of materials as detailed within in FIG. 1. Additionally, any number of adornments can be included upon the support members. In one embodiment, the support members specified herein can be designed in a variety of colors, wherein particular stick colors can even indicate the nature of the supported grain-based edible. For example, a plain grain-based edible made from wheat can have a brown support member; and, a grain-based edible that includes chocolate chips can have a support member colored black. In another embodiment, the support member can include illustrations, designs, pictures, and/or embossments.

FIG. 2A illustrates an exemplary support member having rounded ends and a relatively symmetrical shape in accordance with the inventive arrangements disclosed herein. This symmetrical shape is a classical shape utilized for popsicles and tongue depressors. One advantage of using this shape is that a manufacturing base for the support members already exists, thereby lowering the cost of for acquiring the support members.

FIG. 2B illustrates an exemplary support member with flanged ends in accordance with the inventive arrangements disclosed herein. The flanged end, which is to be extended into the grain-based edible, can strengthen the adhesive characteristics between grain-based edible and the support member. The opposing flanged end can be easier for a consumer to hold than a non-flanged support member.

FIG. 2C illustrates an exemplary support member with a guard in accordance with the inventive arrangements disclosed herein. The guard can serve as a supporting platform for the coupled grain-based edible, thereby preventing the grain-based edible from slipping downward.

FIG. 2D illustrates an exemplary support member having one or more holes in accordance with the inventive arrangements disclosed herein. This support member can substantially enhance adhesive characteristics in embodiments were a coupling of the support member to the grain-based member occurs before baking. The holes can permit the expansion of a leavened dough into the holes during baking resulting in a tight coupling between the support member and the grain-based edible.

FIG. 2E illustrates an exemplary arrow shaped support member in accordance with the inventive arrangements disclosed herein. The arrow shape can be used for marketing purposes to uniquely identify the food product in the mind of the consumers. Further, the arrow shape can prevent downward slippage of the grain-based edible as well as upward slippage of the grain-based edible during ingestion.

FIG. 2F illustrates an exemplary support member having a hook at the end which is extended into the grain-based edible in accordance with the inventive arrangements disclosed herein. The hook can prevent the grain-based edible from sliding upward, off the support member during ingestion.

FIG. 2G illustrates an exemplary support member having screw-able ridges in accordance with the inventive arrangements disclosed herein. These ridges can permit a substantially round support member to be screwed into the food-based product. Further, the ridges provide a fricative element the can enhance the adhesive characteristics of the support member.

FIG. 2H illustrates an exemplary support member having extended teeth in accordance with the inventive arrangements disclosed herein. These teeth can prevent the support member from becoming decoupled from the grain-based edible. In a particular arrangement, the extended teeth can be rounded to prevent injuries during consumption of the grain-based edible. In another embodiment, the teeth can be constructed from an edible substance, such as chocolate, designed to fragment from the centralized portion of the support member and to be consumed along with the grain-based edible.

FIG. 2I illustrates an exemplary support member having inverted teeth in accordance with the inventive arrangements disclosed herein. The inverted teeth can prevent the support member from becoming decoupled from the grain-based edible. One of ordinary skill in the art can appreciate that FIGS. 2A to 2I are for illustrative purposes only and the support member can vary from these exemplary embodiments without departing from the spirit of the invention disclosed herein.

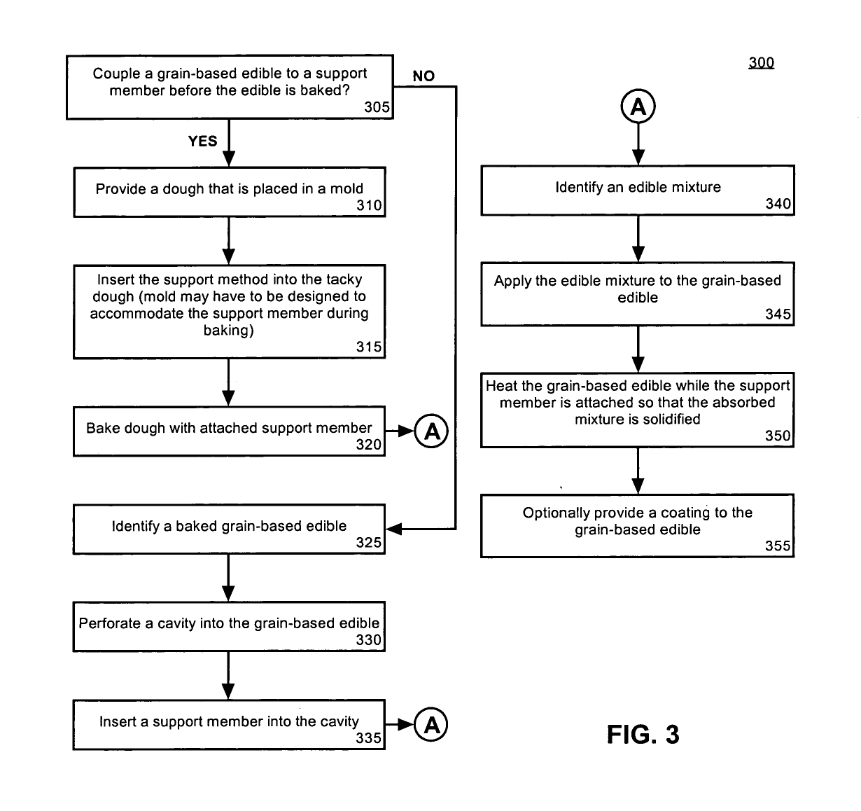

FIG. 3 is a flow chart illustrating a method 300 for affixing a support member to a grain-based edible in accordance with the inventive arrangements disclosed herein. The method can begin in step 305 where, a determination can be made as to whether a grain-based edible is to be coupled to a support member before baking. If so, the method can proceed to step 310, where dough can be created and/or identified. In step 315, a support member can be inserted into the tacky dough. In step 320, the dough can be baked in an oven with the support member attached during the baking process. Appreciably, a mold for baking the dough may have to be designed to accommodate the inclusion of the support member during the baking process. After the bread has been baked, the method can proceed to step 340.

If in step 305 the coupling between the support member and the grain-based edible is not to occur until after the baking of the grain-based edible, the method can proceed from step 305 to step 325. In step 325, a baked grain-based edible can be identified. In step 330, a cavity can be perforated in the grain-based edible. In step 335, the support member can be inserted into the cavity. The method can then proceed to step 340.

In step 340, after a baked grain-based edible has been coupled to a support member, an edible mixture, such as an egg batter, can be identified. In step 345, the edible mixture can be applied to the grain-based edible so that the mixture is absorbed within the grain-based edible. In step 350, the grain-based edible coupled to the support member can be heated, such as by frying, so that the absorbed mixture is approximately solidified. The step 350 enhances the adhesive characteristics between the grain-based edible and support member in a manner that permits the grain-based edible to be held by an extruded portion of the support member. When so held, the grain-based edible can be ingested without the un-ingested portion of the grain-based edible decoupling from the support member. In step 355, a coating, such as powdered sugar, can be optionally applied to the grain-based edible.

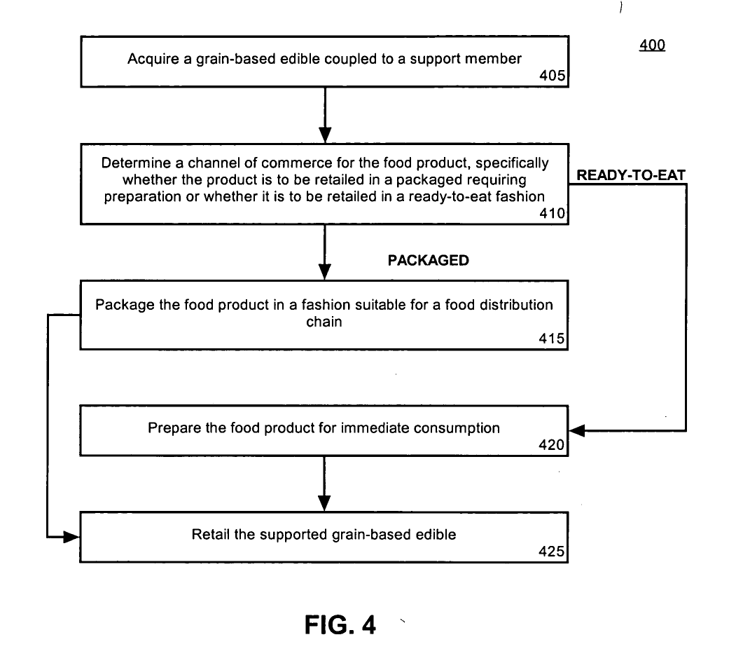

FIG. 4 is a flow chart illustrating a method 400 for distributing a supported grain-based edible in accordance with the inventive arrangements disclosed herein. The method can begin in step 405 where grain-based edible coupled to a support member, such as described in FIG. 1, can be acquired. In step 410, a channel of commerce for the food item can be determined. If the determined channel sells the food item in a packaged form, the method can proceed to step 415. In step 415, the acquired food product can be suitably packaged and transported to one or more retail sites. For example, if the food product is sold fresh, preservatives can be added and the food product can be sealed for sanitary reasons. Moreover, the package can be dated to assure freshness. Fresh supported grain-based edibles can be sold at gas stations, from vending machines, from bakeries, and the like. In another example, the food product can be frozen and distributed within a frozen food section of a retail outlet. In a further example, the frozen grain-based edible can be prepared using a microwave.

If in step 410, the determined channel of commerce sells the food item in a ready to eat form, the method can proceed from step 410 to step 420. In step 420, the food item can be prepared in a suitable fashion by the retailer. For example, the grain-based edible can be sold at concession stands at sporting events. In another example, the grain-based edible can be sold at fast-food restaurants as a breakfast item. Regardless of the distribution channel, in step 425, the prepared and/or packaged grain-based food item can be retailed to a customer.

This invention can be embodied in other forms without departing from the spirit or essential attributes thereof. Accordingly, reference should be made to the following claims, rather than to the foregoing specification, as indicating the scope of the invention.

1. A method for affixing a support member to a grain-based edible comprising the steps of:
directly coupling an extruded support member to a grain-based edible;
soaking the grain-based edible coupled to the support member in an edible mixture after the grain-based edible has been baked; and
heating the grain-based edible coupled to the support member until the mixture absorbed within the grain-based edible is approximately solidified, wherein said heating enhances the adhesive characteristics between the grain-based edible and the support member such that the adhesive characteristics are sufficient to permit the grain-based edible to be held by the extruded portion of the support member during ingestion of the grain-based edible without an un-ingested portion of the grain-based edible decoupling from the support member.

2. The method of claim 1, wherein said coupling further comprises the steps of:
coupling the support member to a tacky dough; and
baking the dough with the support member attached, wherein the baked dough forms the grain-based edible.

3. The method of claim 1, wherein said coupling further comprises the steps of:
perforating a cavity within the grain-based edible after the grain-based edible has been baked; and
inserting the support member into the cavity.

4. The method of claim 1, wherein said grain-based edible has an approximately rectangular shape, wherein said shape consists of a height within one third of a length, and wherein a width of said shape is less than one fourth of said height.

5. The method of claim 4, said coupling step further comprising the step of:
positioning the support member within the grain-based edible so that the support member is approximately within the center of said width and approximately within the center of said length.

6. The method of claim 4, said coupling step further comprising the step of:
positioning the support member within the grain-based edible so that an inserted length of said support member equals at least half of said height.

7. The method of claim 1, wherein said heating further comprises the step of:
frying the grain-based edible coupled to the support member over a direct heat in at least one of an oil and a fat.

8. The method of claim 1, wherein said mixture comprises at least one of a milk and a milk substitute.

9. The method of claim 1, wherein said mixture comprises at least one of an egg and an egg substitute.

10. The method of claim 1, comprising the step of:
before said coupling step, coating a portion of said support member with an edible bonding agent; wherein said heating step further comprises the step of bonding said grain-based edible to said support member through said edible bonding agent.

11. A grain-based food product comprising:
a grain-based edible;
a support member coupled to said grain-based edible wherein one segment of the support member is centrally enclosed within said grain-based edible, and wherein another segment of the support member extrudes from said grain-based edible; and
an edible mixture, wherein edible mixture is configured to be absorbed by said grain-based edible after said grain-based edible has been baked, and wherein the coupling of said support member to said grain-based edible is based at least in part upon a solidification of said absorbed edible mixture through heating.

12. The product of claim 11, wherein said grain-based edible comprises a baked dough, said dough comprising a flour and leavening agent.

13. The product of claim 11, wherein said grain-based edible comprises embedded pieces of a non-grain-based edible.

14. The product of claim 13, wherein said embedded pieces comprises at least one piece selected from the group consisting of a fruit piece, a nut, and a candy.

15. The product of claim 11, wherein said grain-based edible is a type of French toast.

16. The product of claim 11, further comprising an edible outer coating for said grain-based edible, wherein said edible outer coating is selected from the group consisting of powdered sugar, candy sprinkles, cinnamon, syrup, a honey, a butter, a jam, a chocolate, and fruit slices.

17. The product of claim 11, wherein said support member comprises a non-edible substance comprising at least one of a wood and a plastic.

18. The product of claim 11, wherein said support member is formed from edible substances.

19. The product of claim 18, wherein said edible substances comprises at least one substance selected from the group consisting of a pretzel, a sugar stick, a rock candy, a fruit bar, a chocolate bar, a toasted bread, and a cracker.

20. The product of claim 11, wherein at least a portion of the enclosed segment of said support member is coated with an edible coating.

21. The product of claim 20, wherein said edible coating comprises a coated selected from the group consisting of a chocolate, a candy, a sugar, a syrup, a butter, a jam, a jelly, and a honey.

22. A food product comprising:
French toast;
a support member, wherein one segment of the support member is embedded within the French toast, wherein another segment of the support member is extruded from the French toast; and
a means for coupling said French toast to said support member that permits the French toast to be held by the extruded portion of the support member during ingestion without an un-ingested portion of the French toast decoupling from the support member, wherein a strength of coupling means is enhanced through heating said French toast after the French toast is coupled to the support member, wherein said heating solidifies of a mixture absorbed within the French toast.
